(19) United States
(12) Patent Application Publication
(10) Pub. No.: US 2024/0312197 A1
(43) Pub. Date: Sep. 19, 2024

(54) UNSUPERVISED DOMAIN ADAPTATION OF MODELS WITH PSEUDO-LABEL CURATION

(71) Applicant: SRI International, Menlo Park, CA (US)

(72) Inventors: Han-Pang Chiu, Princeton Junction, NJ (US); Niluthpol C. Mithun, Dayton, NJ (US); Supun Samarasekera, Skillman, NJ (US); Abhinav Rajvanshi, Plainsboro, NJ (US); Xingchen Zhao, Malden, MA (US); Md Nazmul Karim, Pittsburgh, PA (US)

(21) Appl. No.: 18/605,594

(22) Filed: Mar. 14, 2024

Related U.S. Application Data
(60) Provisional application No. 63/454,570, filed on Mar. 24, 2023.
(60) Provisional application No. 63/452,028, filed on Mar. 14, 2023.

(51) Int. Cl. G06V 10/82; G06V 10/771; G06V 10/774; G06V 10/776

(52) U.S. Cl. CPC G06V 10/82; G06V 10/771; G06V 10/7753; G06V 10/776

(57) ABSTRACT

In general, techniques are described for unsupervised domain adaptation of models with pseudo-label curation. In an example, a method includes generating a plurality of pseudo-labels for a dataset of unlabeled data using a source machine learning model; estimating a reliability of each pseudo-label of the plurality of pseudo-labels using one or more reliability measures; selecting a subset of the plurality of pseudo-labels having estimated reliabilities that satisfy a reliability threshold; and training, using one or more curriculum learning techniques, a target machine learning model starting with the selected subset of the plurality of pseudo-labels and the corresponding unlabeled data.

This application claims the benefit of U.S. Patent Application No. 63/452,028, filed Mar. 14, 2023 and U.S. Patent Application No. 63/454,570, filed Mar. 24, 2023, both of which are incorporated by reference herein in their entirety.

### TECHNICAL FIELD

This disclosure is related to machine learning systems, and more specifically to unsupervised domain adaptation of models with pseudo-label curation.

### BACKGROUND

Currently, Unsupervised Domain Adaptation (UDA) methods train a model on a labeled source domain and then adapt the trained model to an unlabeled target domain. UDA methods are helpful when acquiring labeled data for the target domain is expensive or infeasible. However, the traditional UDA approaches typically require access to the source data during the adaptation process. Access to source data may raise privacy and resource constraints concerns. Devices with limited resources may struggle to store and access the source data. Source-Free Domain Adaptation (SFDA) approaches address the limitations of UDA by achieving domain adaptation without requiring access to the source data during the adaptation stage.

Semantic segmentation models trained on labeled datasets often struggle when applied to real-world scenarios due to domain bias. Labeled datasets provide a controlled environment with pixel-by-pixel labels for objects in images (e.g., daytime driving scenes with cars, lanes, pedestrians clearly marked). The model trained on the labeled datasets (source domain) is biased towards the specific characteristics of that domain (e.g., good lighting, clear road markings). When applied to the target domain (e.g., nighttime driving), such biases may lead to poor performance because the model has not seen the variations in lighting, weather, and the like.

### SUMMARY

Current state of the art approaches in SFDA rely on pseudo-label refinement based self-training. In other words, an SFDA model may generate pseudo-labels for the unlabeled target data. These pseudo-labels may then be refined to improve their accuracy. The refined pseudo-labels may be used to retrain the SFDA model. However, such approaches face two key challenges. The initial pseudo-labels may be inaccurate, potentially harming performance. Refinement often involves a large memory bank to store information, hindering resource-constrained devices.

Previous SFDA approaches may propagate noise throughout the process, potentially harming performance.

In general, techniques are described for a curriculum learning aided self-training framework for SFDA. The techniques can adapt efficiently and reliably to changes across domains based on selective pseudo-labeling. For example, instead of using all pseudo-labels, the disclosed Curriculum Learning for Source-Free Domain Adaptation (C-SFDA) employs curriculum learning techniques. C-SFDA starts with a small subset of the most reliable pseudo-labels for self-training. As the trained model improves, the training may gradually incorporate more pseudo-labels based on their estimated reliability. In some examples, C-SFDA uses a confidence measure to estimate the reliability of each pseudo-label. The most confident labels (in other words, those labels the model trusts the most) will be included in the training set.

The techniques may provide one or more technical advantages that realize at least one practical application. By selectively choosing high-confidence labels, C-SFDA reduces the number of labels to be accessed and thereby reduces the need for a large memory bank, which can significantly reduce the resource overhead. By using only reliable labels, C-SFDA may also avoid amplifying noise and may improve domain adaptation accuracy. The absence of or reduction in size of a memory bank makes C-SFDA efficient and lightweight, suitable for resource-constrained devices. Extensive experiments show that C-SFDA outperforms previous State Of The Art (SOTA) approaches on both image recognition and semantic segmentation tasks. C-SFDA may be readily applied to online test-time domain adaptation scenarios, where the target domain data arrives sequentially.

The disclosed techniques may also provide a self-training teacher-student framework for unsupervised domain adaptation that may tackle the challenge of adapting models trained from labeled source data to unlabeled target data using self-refinement of pseudo-labels. In one non-limiting example, the disclosed techniques address challenges of nighttime semantic segmentation. The purpose of the self-training framework may be to improve the quality of pseudo-labels generated for the unlabeled target domain data using a refinement neural network. The refinement neural network may be specifically designed to pay more attention to features from the teacher model that are less affected by domain shift (less noisy features). This ensures the refinement process relies on information that generalizes better to the target domain.

In an example, a method or unsupervised domain adaptation includes generating a plurality of pseudo-labels for a dataset of unlabeled data using a source machine learning model; estimating a reliability of each pseudo-label of the plurality of pseudo-labels using one or more reliability measures; selecting a subset of the plurality of pseudo-labels having estimated reliabilities that satisfy a reliability threshold; and training, using one or more curriculum learning techniques, a target machine learning model starting with the selected subset of the plurality of pseudo-labels and the corresponding unlabeled data.

In an example, a computing system for unsupervised domain adaptation includes: processing circuitry in communication with storage media, the processing circuitry configured to execute a machine learning system configured to: generate a plurality of pseudo-labels for a dataset of unlabeled data using a source machine learning model; estimate a reliability of each pseudo-label of the plurality of pseudo-labels using one or more reliability measures; select a subset of the plurality of pseudo-labels having estimated reliabilities that satisfy a reliability threshold; and train, using one or more curriculum learning techniques, a target machine learning model starting with the selected subset of the plurality of pseudo-labels and the corresponding unlabeled data.

In an example, a method for unsupervised domain adaptation includes: generating a plurality of pseudo-labels for a dataset of unlabeled data using a source machine learning model; refining the plurality of pseudo-labels to reduce noise in the plurality of pseudo-labels; and training, using the refined pseudo-labels, a target machine learning model.

In an example, a computing system for unsupervised domain adaptation includes: processing circuitry in communication with storage media, the processing circuitry configured to execute a machine learning system configured to: generate a plurality of pseudo-labels for a dataset of unlabeled data using a source machine learning model; refine the plurality of pseudo-labels to reduce noise in the plurality of pseudo-labels; and train, using the refined pseudo-labels, a target machine learning model.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates an enhanced domain adaptation system, in accordance with techniques of the disclosure.

FIG. 2 is a detailed block diagram illustrating an example computing system, in accordance with the techniques of the disclosure.

FIG. 3 is a conceptual diagram illustrating source free domain adaptation according to techniques of this disclosure.

FIG. 4 is a conceptual diagram illustrating a method that uses teacher predictions to train the student model according to techniques of this disclosure.

FIG. 5 illustrates self-training with pseudo label self-refinement, according to techniques of this disclosure.

FIG. 6 is a conceptual diagram illustrating an example of training a refinement neural network, according to techniques of this disclosure.

FIG. 7 is a flowchart illustrating an example mode of operation for a machine learning system to perform SFDA, according to techniques described in this disclosure.

FIG. 8 is a flowchart illustrating an example mode of operation for a machine learning system to perform self-refinement of pseudo-labels, according to techniques described in this disclosure.

Like reference characters refer to like elements throughout the figures and description.

### DETAILED DESCRIPTION

Deep learning networks are often trained on data from specific sensors. When new sensors are introduced, performance may drop significantly. Re-training on new sensor data is time-consuming and costly due to labeling requirements. New sensors may have different characteristics (resolution, noise, etc.). Data distributions may differ between old and new sensors. Labeling new data for re-training is often impractical. Domain adaptation may align features from old and new sensors to bridge the domain gap.

Domain adaptation techniques may include data augmentation, adversarial training, and feature alignment. UDA may align features without labeled data from the new sensor. UDA may leverage techniques like self-supervised learning and domain-invariant representations.

Traditional approaches to adapting deep learning models for new sensor data typically collect and label data from the new sensor, then train a new model from scratch. Traditional approaches may provide high accuracy if enough data is available. However, traditional approaches may be time-consuming and expensive due to labeling needs. UDA approaches may adapt a model trained on a labeled source domain to an unlabeled target domain (e.g., new sensor data). UDA approaches do not require new data labeling, which may save time and cost. However, UDA approaches rely on having access to the labeled source data, which may not always be feasible. In contrast, SFDA approaches may adapt a model without any access to the original source data, only using the model and unlabeled target data. SFDA approaches may overcome privacy concerns and resource limitations of devices.

Labels generated by the SFDA approaches may be inaccurate, leading to model memorization issues. Accordingly, existing SFDA approaches using pseudo-label refinement face limitations due to noise and memory requirements.

C-SFDA is a new technique for adapting deep learning models to new sensor data without access to the original training data (source data). Unlike other SFDA methods that rely on noisy pseudo-labels and memory-intensive refinement, C-SFDA addresses these issues through two key features: curriculum learning and selective pseudo-labeling. C-SFDA may gradually increase the difficulty of the learning task for the model. By focusing on the easiest examples first, the model may learn basic concepts before tackling more complex ones, leading to faster convergence and better overall performance. Instead of blindly using all generated pseudo-labels, C-SFDA may employ a selection methodology based on reliability scores that indicate a confidence level (also referred to herein as “confidence scores”).

The disclosed techniques may also provide a self-training teacher-student framework for unsupervised domain adaptation that may tackle the challenge of adapting models trained from labeled source data to unlabeled target data using self-refinement of pseudo-labels . In one non-limiting example, the disclosed techniques address challenges of nighttime semantic segmentation. The purpose of the self-training framework may be to improve the quality of pseudo-labels generated for the unlabeled target domain data using a refinement neural network. The refinement neural network may be specifically designed to pay more attention to features from the teacher model that are less affected by domain shift (less noisy features). This ensures the refinement process relies on information that generalizes better to the target domain

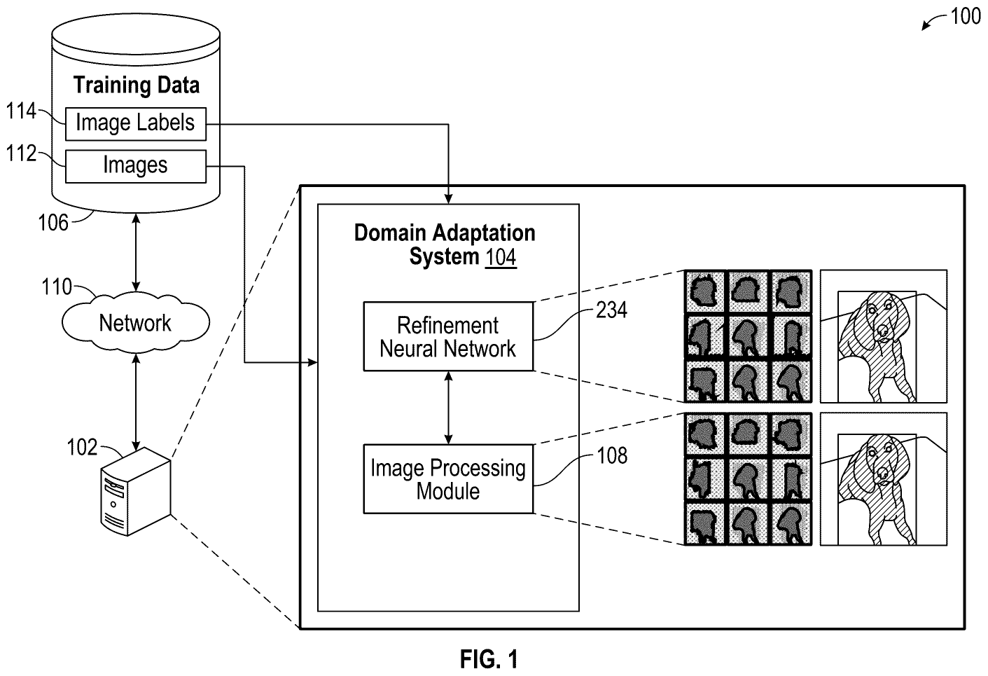

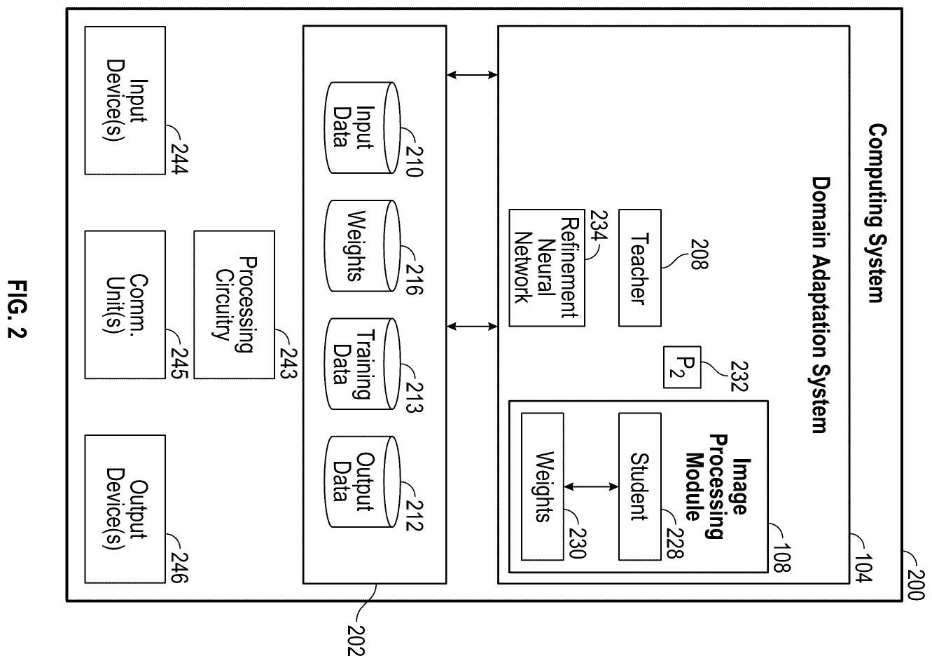

FIG. 1 illustrates an enhanced domain adaptation system implementing various techniques presented herein. System 100 includes one or more various computing devices, including computing system 102. As shown in FIG. 1, computing system 102 hosts and/or implements a domain adaptation system 104. As discussed throughout, domain adaptation system 104 may be trained to perform C-SFDA and may be trained to perform image processing within images using self-refined pseudo-labels. Other implementations of system 100 may include additional, alternative, and/or fewer computing devices. An exemplary, but non-limiting implementation of a computing device is discussed in conjunction with at least computing system 200 of FIG. 2. That is, at least structures, functionalities, or features of computing system 200 may be included in computing system 102.

System 100 may also include a training data repository 106. Domain adaptation system 104 may train a model, such as image processing module 108, using C-SFDA, when there is no source domain data. In addition, Domain adaptation system 105 may adapt a model trained from labeled source data to unlabeled target data. Training data repository 106 may include one or more image databases, such as but not limited to image database 112. Training data repository 106 may additionally include an image label database 114, which may include image-level labels and/or pseudo-labels for the objects depicted within images 112. Thus, images 112 and labels (including pseudo-labels) 114 may form an image-level labeled training dataset for training image processing module 108 for the task of image segmentation, for example. Image database 112 may include millions of instances of images, encoded via image data, and label database 114 may include the corresponding image-level labels and/or pseudo-labels for the images. The combination of image database 112 and labels 114 may include a set of image-level labeled images. Labels 114 may include image-level labels for images 112 and may exclude pixel-wise labels for images 112. A set of image-level labeled images may comprise a combination of images 112 and labels/pseudo-labels 114.

A general or specific communication network, such as but not limited to communication network 110, may communicatively couple computing system 102, training data repository 106, and/or any other computing devices or systems included in system 100. Communication network 110 may be any communication network, including any wired and/or wireless communication technologies, wired and/or wireless communication protocols, and the like. Communication network 110 may be any communication network that communicatively couples a plurality of computing devices and storage devices in such a way as to computing devices to exchange information via communication network 110.

Training data repository 106 may be implemented by one or more storage devices that may include volatile and/or non-volatile memory for storing digital data. A storage device may include non-transitory storage media. In some aspects, training data repository 106 may be stored on a storage device distributed over multiple physical storage devices. Thus, training data repository 106 may be implemented on a virtualized storage device. For instance, one or more “cloud storage” services and/or service providers may provide, implement, and/or enable training data repository 106. A third party may provide such cloud services. Training data, such as but not limited to data used by domain adaptation system 104, may be temporarily or persistently stored in training data repository 106. In some cases, training data repository 106 is a component of computing system 102.

In accordance with techniques of this disclosure, domain adaptation system 104 may use pseudo-labels and curriculum learning to effectively train a machine learning model on unlabeled data. Machine learning models often require vast amounts of labeled data to perform well. However, labeling data may be expensive and time-consuming. Unlabeled data, on the other hand, is often plentiful. Domain adaptation system 104 may bridge this gap by allowing models to learn from unlabeled data from a different domain (source domain) and apply that knowledge to a new domain (target domain) with limited labeled data. A pre-trained model (e.g., teacher model 208 shown in FIG. 2) may predict labels for the unlabeled data. These predictions become the initial “pseudo-labels” 114. Domain adaptation system 104 may estimate reliability of each pseudo-label using one or more reliability measures. In various implementations, such reliability measures may include, but are not limited to, reliability scores. confidence scores, uncertainty estimates, or other metrics. Domain adaptation system 104 may assign each pseudo-label a reliability score that indicates a confidence level for the pseudo-label. Domain adaptation system 104 may select a subset of pseudo-labels 114 with reliability scores that satisfy a pre-defined reliability score threshold for use by domain adaptation system 104 in training the machine learning model. The training starts with easily learnable/reliable data, gradually progressing to more difficult/less reliable examples. In an aspect, domain adaptation system 104 may perform gradual adjustment of loss functions, data sampling based on difficulty. By using reliable pseudo-labels first, domain adaptation system 104 avoids propagation of errors and builds a stronger foundation for the machine learning model.

In accordance with techniques of this disclosure, in cases when a model trained from labeled source data needs to be adapted to unlabeled target data domain, adaptation system 104 may use pseudo-label refinement to effectively train a target machine learning model. A pre-trained model (e.g., teacher model 208 shown in FIG. 2) may generate a plurality of pseudo-labels 114. Domain adaptation system 104 may refine the plurality of pseudo-labels using a refinement neural network, so that the pseudo-labels are less noisy. Domain adaptation system 104 may train student model 228 using the refined pseudo-labels 114.

FIG. 2 is a block diagram illustrating an example computing system 200. Computing system 200 may represent computing system 102 shown in FIG. 1. As shown, computing system 200 comprises processing circuitry 243 and memory 202 for executing a domain adaptation system 104 that hosts and/or implements domain adaptation system 104. Domain adaptation system 104 applies C-SFDA or refined pseudo-labels (depending on the availability of source domain data) to train a machine learning model in accordance with techniques of this disclosure.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system 103, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., domain adaptation system 104, teacher (source) model 208, refinement neural network 234), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute domain adaptation system 104 using virtualization modules, such as a virtual machine or container executing on underlying hardware. One or more of such modules may execute as one or more services of an operating system or computing platform. Aspects of domain adaptation system 104 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, domain adaptation system 104 may receive input data from an input data set 210 and may generate output data 212. Input data 210 and output data 212 may contain various types of information. For example, input data 210 may include images 112, labels 114 and the like. Output data 212 may include information such as, but not limited to (i) refined pseudo-labels and (ii) segmentation masks.

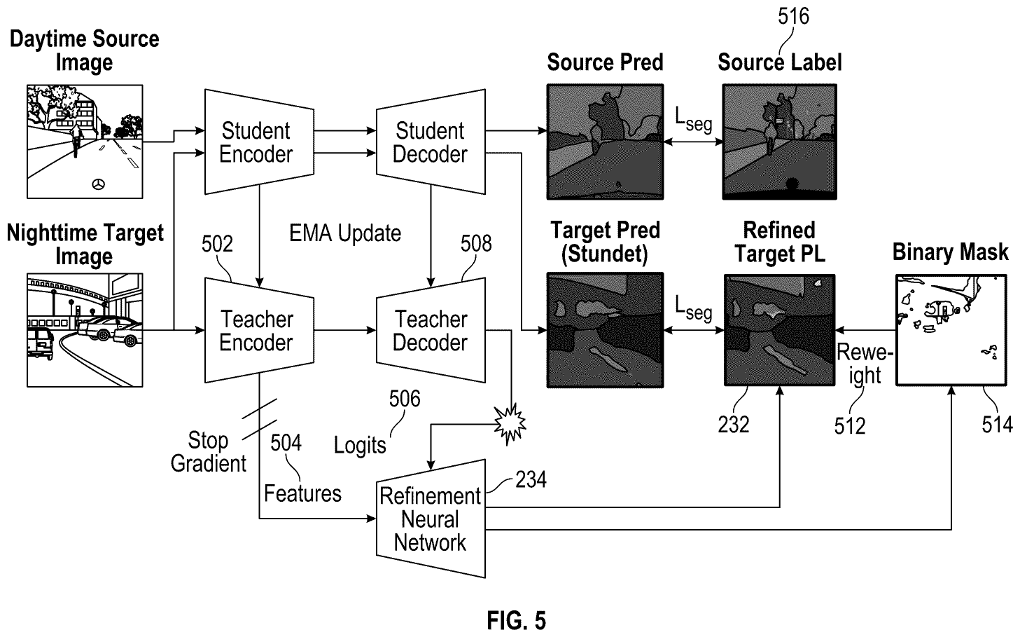

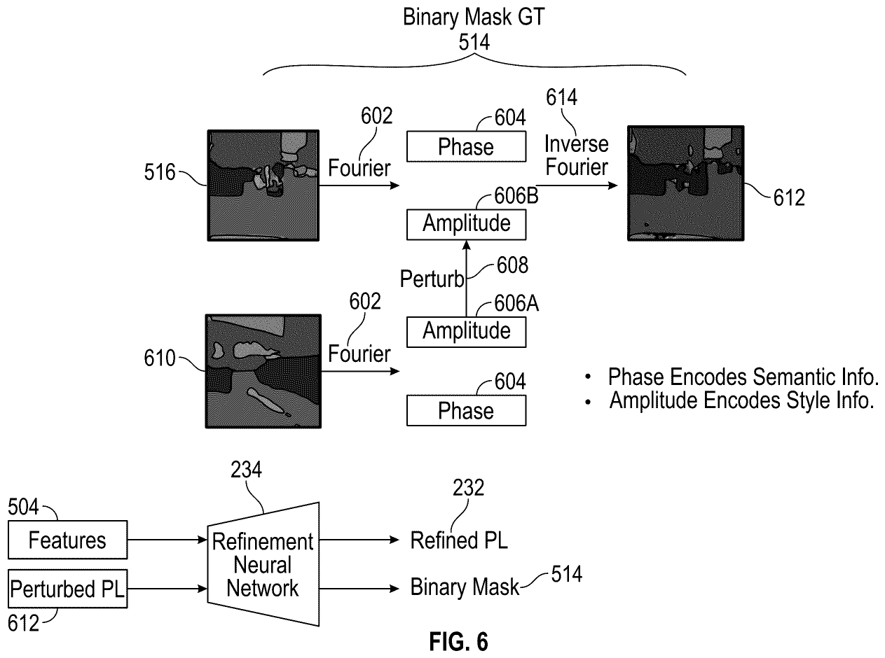

domain adaptation system 104 may process training data 213 that may be a subset of training data 106 described above to train image processing module 108, in accordance with techniques described herein. For example, domain adaptation system 104 may apply a C-SFDA training method that includes processing training data 213. Alternatively, domain adaptation system 104 may apply a self-refined pseudo-labels training method described below in conjunction with FIGS. 5 and 6. Training data 213 may include, but is not limited to, images 112, labels (including pseudo-labels) 114, and the like. Domain adaptation system 104 may process input data 210 to generate relevant updated/refined pseudo-labels that may be included in the training data 213.

Conventional SFDA systems treat all pseudo-labels equally, even if some are inaccurate (“noisy”). Such noise may propagate throughout the self-training process, hindering accuracy. SFDA systems often rely on a large memory bank to store all pseudo-labels, requiring significant computational resources.

In contrast, domain adaptation system 104 may choose only the most reliable pseudo-labels based on a confidence measure. By focusing on reliable labels, domain adaptation system 104 may achieve better domain adaptation performance compared to methods that utilize all pseudo-labels. Curriculum learning allows for gradual adaptation to more complex data.

Domain adaptation system 104 does not require any labeled data from the new sensor domain for adaptation. Unsupervised adaptation may save time and resources compared to supervised methods that may need extensive labeling efforts. Unsupervised adaptation may leverage unlabeled data from the new domain and may use self-training to gradually adapt the model to the new sensor characteristics.

Selection of reliable pseudo-labels may lead to higher accuracy on the new sensor data compared to methods that use all pseudo-labels indiscriminately. Additionally, the focus on high-confidence labels may help the model capture the essential features of the new sensor data more effectively. Elimination or reduction of the memory bank by the application of C-SFDA by domain adaptation system 104 may reduce computational resources needed for adaptation. Memory bank elimination or reduction may make C-SFDA more cost-effective compared to other adaptation techniques, especially for deploying models on resource-constrained devices. By reducing or eliminating the need to access original sensor data in training data, domain adaptation system 104 may bypass potential privacy concerns and data accessibility limitations.

Overall, domain adaptation system 104 may offer a compelling solution for adapting existing deep learning models to new sensor domains that may have limited or no labeled data in a faster, more accurate, and more economical way. For example, image recognition models trained on daytime photos may be transferred to work effectively on nighttime surveillance footage. As another example, medical diagnosis models trained on one type of imaging equipment may be adapted to function accurately with another equipment in a different healthcare setting. The cluttered and dynamic nature of indoor environments requires significant amounts of labeled data for tasks like obstacle detection, which might not be readily available for diverse indoor settings. In yet another example, domain adaptation system 104 may be used in various industrial settings and/or to adapt a model from a simulated to a real world environment.

The selective pseudo-labeling and curriculum learning approach applied by domain adaptation system 104 may reduce noise in the training data compared to traditional methods that use all pseudo-labels equally. Such focus on reliable labels may allow the adapted model to better capture the essential features of the new sensor data, leading to higher accuracy in real-world applications.

Domain adaptation system 104 may in some instances rely solely on unlabeled data from a new sensor domain, making it suitable for offline adaptation. Unlabeled data is particularly beneficial when online access to the original sensor data or labeled data is limited. Such offline capability may open up domain adaptation system 104 for use in various scenarios, such as, but not limited to adapting models for robots operating in remote environments or for embedded systems with limited connectivity.

Domain adaptation system 104 offers a cost-effective and efficient way for sensor manufacturers to adapt existing deep learning models to their new sensor systems. By avoiding the need for extensive data collection and labeling for the new sensor, domain adaptation system 104 may reduce development time and costs, making it an attractive option for the industry.

Manually labeling cach pixel in images for object segmentation is a laborious and time-consuming process. The expense of collecting and labeling extensive nighttime data for re-training may be prohibitive, especially in resource-constrained settings. Nighttime images may exhibit drastic variations in visual characteristics compared to daytime images due to low-light conditions, artificial lighting, and altered object appearances.

Models, such as image processing module 108, trained solely on daytime data often fail to generalize effectively to nighttime scenarios, leading to decreased accuracy in segmentation tasks. Many semantic segmentation tasks, such as self-driving cars and surveillance systems, demand real-time processing of sensor data. While labeled nighttime data is scarce, unlabeled nighttime images or videos are often readily available. Methods that may effectively adapt models using unlabeled data from the new domain are highly sought after to address the challenges mentioned above. For example, labeled data for nighttime driving (the target domain) is scarce, making re-training on target domain data impractical. Models trained only on source domain data often fail to generalize well to the target domain due to significant differences in visual characteristics between daytime and nighttime images.

UDA techniques aim to adapt models to the target domain without requiring any labeled data from that domain. Self-Training (ST) is a popular UDA technique that involves using the model itself to generate pseudo-labels for unlabeled target domain data and then re-training on those pseudo-labels. In an aspect, domain adaptation system 104 may utilize a teacher model 208 and a student model 228 for training image processing module 108. Teacher model 208 may be a more robust model, typically an exponentially moving average of the student model (SM) weights 230, that may be used to generate pseudo-labels. Student model 228 may be the main model being trained, which may learn from the pseudo-labels 232 provided by teacher model 208. In conventional systems, the significant differences between daytime and nighttime images often lead to the teacher model 208 generating inaccurate pseudo-labels 232 for the target domain. Using the noisy pseudo-labels 232 for training may actually harm the performance of student model 228 on the target domain over time.

In an aspect, instead of simply using the pseudo-labels 232 of teacher model 208 directly, the domain adaptation system 104 may utilize a specialized “refinement neural network” module 234. The refinement neural network 234 may refine the pseudo-label 232 to improve its accuracy. In one example, teacher model 208 may include an encoder and a decoder (not shown in FIG. 2). Features from the teacher encoder capture the essential information learned by the teacher model 208 about both source and target domains. In a neural network, each layer performs a weighted sum of its inputs and then applies an activation function to introduce non-linearity. Logits refer to the values before this activation function is applied in the final layer of a segmentation model, as shown in FIG. 5.

The refinement neural network 234 may attempt to predict the correct segmentation mask for the pseudo-labeled target image. This predicted mask may essentially represent an “educated guess” by refinement neural network 234 about the true object segmentation.

The predicted mask may guide the refinement process. By focusing on areas where refinement neural network 234 is most confident about the pseudo-label's accuracy, domain adaptation system 104 may encourage refinement neural network 234 to concentrate on less noisy features and discard potentially misleading parts of the original pseudo-label.

In an aspect, once refinement neural network 234 generates a new, potentially improved pseudo-label 232, domain adaptation system 104 may use the predicted mask as a weighting factor to refine pseudo-label 232. Refinement neural network 234 aims to improve the accuracy of pseudo-labels 232 generated by teacher model 208, which often contain inaccuracies due to domain differences. In an aspect, teacher model 208 may include a teacher encoder and a teacher decoder. Refinement neural network 234 may use features and image logits from the teacher encoder as input. As noted above, the features from the teacher encoder may represent the teacher model's 208 understanding of the image content, capturing essential details and patterns. The image logits may represent the values before an activation function is applied in the final layer of the model.

In an aspect, output of the refinement neural network 234 may be refined pseudo-label 232 that is potentially more accurate than the original one. Refinement neural network 234 may combine the input features and image logits to generate a prediction of the “correct” segmentation mask for the target image. In an aspect, the predicted mask may represent the best estimate by refinement neural network 234 of the true segmentation, based on knowledge of characteristics of the teacher model 208 and the current image features.

Refinement neural network 234 may focus on areas where the refinement neural network 234 has higher confidence in the correctness of the original pseudo-label 232, while de-emphasizing regions where refinement neural network 234 suspects noise or inconsistencies. The predicted mask may be used as a weighting factor during the re-training of the student model 228. Pixels in the refined pseudo-label 232 that align well with the predicted correct mask may be assigned higher weights 216, while those pixels that deviate significantly may be given lower weights 216. Such a weighting scheme may ensure that student model 228 focuses more on the trustworthy parts of the refined pseudo-labels 232, reducing the influence of potentially noisy regions.

The predicted mask may help guide refinement neural network 234 towards the true segmentation, further enhancing the quality of the refined labels 232. Unlike conventional approaches that require paired day-night datasets for training, the disclosed system may only rely on unlabeled nighttime data. The domain adaptation system 104 may completely avoid the need for manual labeling of the new nighttime data. By combining the above factors, domain adaptation system 104 may achieve dramatic cost reduction in training the model for the new sensor.

In an aspect, by significantly increasing accuracy while reducing training costs, the disclosed domain adaptation system 104 may open up exciting possibilities for various applications. For example, in self-driving cars, improved nighttime object detection and segmentation may enhance safety and reliability. In surveillance systems, more accurate analysis of nighttime video feeds may boost security and crime prevention efforts. In medical imaging, adapting models to different imaging modalities may increase diagnostic accuracy and improve patient care.

In summary, Deep neural networks (DNNs) have achieved remarkable success in various visual recognition tasks such as, but not limited to, image classification and object detection. However, DNN performance may significantly degrade when there is a shift in the data distribution between the training (source) domain and the test (target) domain. Such difference in data characteristics is called domain shift.

Most UDA approaches require access to the labeled source data during adaptation. In an aspect, source-data dependency may limit application of UDA approaches in several real-world scenarios. In applications with limited computational resources, storing and processing the source data may be impractical. To overcome the aforementioned limitations, the field of SFDA has emerged.

SFDA may be advantageous, for example, in case of privacy concerns or resource constraints. Self-training approaches rely on generating and using pseudo-labels for the unlabeled target data. Using noisy labels right away may lead the model to memorize spurious patterns and hinder model's ability to learn from true information later. Refining pseudo-labels often requires a memory bank to store all intermediate labels, which may be resource-intensive on limited devices.

Domain adaptation system 104 may also reduce or even eliminate the need for a memory bank for storing labels, further reducing resource requirements. By addressing noise and resource limitations, domain adaptation system 104 may achieve better performance on various tasks like, but not limited to, image recognition and semantic segmentation.

As noted above, SFDA aims to adapt a model to the target domain using only a pre-trained model from the source domain and unlabeled data from the target domain. SFDA offers several advantages over traditional UDA. There is no need to share or access sensitive source data. SFDA may be implemented on devices with limited resources.

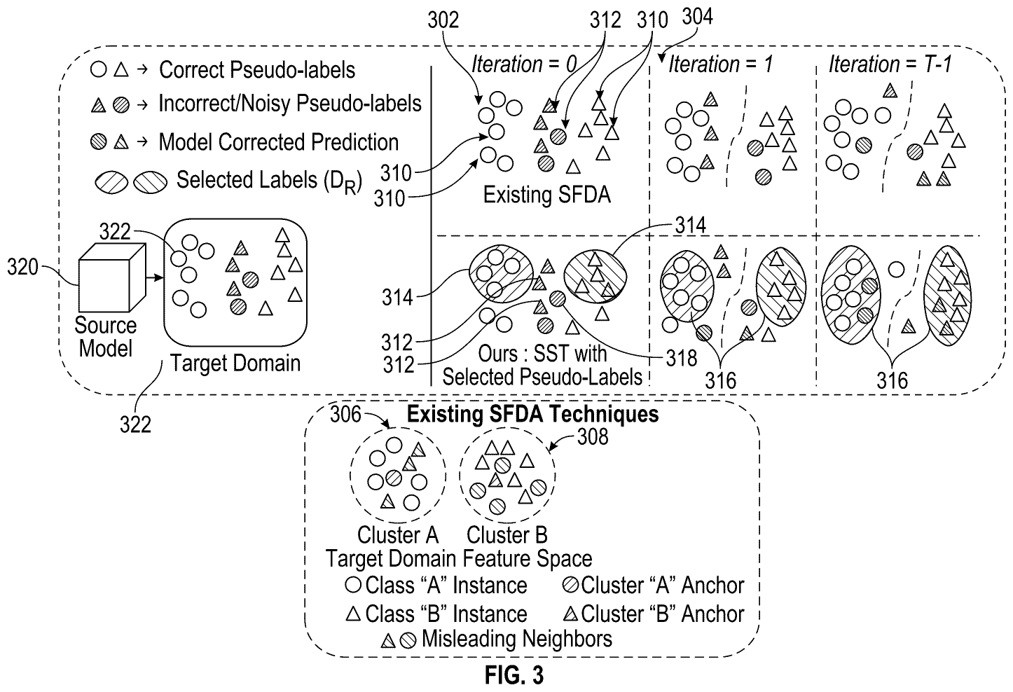

FIG. 3 is a conceptual diagram illustrating source free domain adaptation according to techniques of this disclosure. SFDA approaches often leverage cluster structure in the feature space to refine pseudo-labels. Samples within a cluster might have incorrect pseudo-labels, thus propagating noise.

As shown in the top row of FIG. 3, at early stages of adaptation 302-304 by conventional SFDA approaches, the cluster structure-based label information may be severely misleading or noisy due to limited target domain knowledge. Such label noise may negatively impact the subsequent cluster structure (e.g., cluster A 306 and cluster B 308), as the quality of pseudo-labels further influences clustering effectiveness.

The presence of inevitable label noise in carly training iterations 302-304 may become a critical issue in SFDA and demands proper attention. Distributing cluster knowledge among neighbor samples in the existing SFDA approaches often requires a memory bank, posing a significant burden on resource-constrained devices.

Most memory bank-dependent SFDA approaches are not suitable for online test-time domain adaptation, an emerging area in UDA where new target data arrives sequentially. The disclosed techniques address these challenges by using a memory bank free approach. As shown in FIG. 3, in SFDA, source model 320, which may be a component of training data repository 106 shown in FIG. 1, provides pseudo-labels 310 for target domain data. However, the provided labels often contain significant noise 312.

Using all pseudo-labels for Supervised Self-Training (SST) with cross-entropy loss may be detrimental due to noise propagation. Instead of using all pseudo-labels 310-312, domain adaptation system 104 may use a selective technique. Domain adaptation system 104 may first identify the most reliable pseudo-labels 314 based on certain criteria, such as, but not limited to, confidence and consistency of predictions. Domain adaptation system 104 may initially use only these high-quality pseudo-labels 314 for SST. As training progresses, domain adaptation system 104 may gradually incorporate more pseudo-labels 314-316 into the training process. For example, subsequent iterations may include additional pseudo-labels 316 in the training iterations, whereas prior iterations did not include pseudo-labels 316. This selective and progressive strategy aims to prevent model degradation due to carly reliance on noisy labels.

The disclosed techniques may eventually correct noisy predictions. As shown in FIG. 3, memorizing noisy labels early on may hinder noise-free learning in later stages. In an aspect, domain adaptation system 104 addresses Early Training-Time Memorization (ETM) by employing a curriculum learning framework. Curriculum learning framework is a machine learning training technique inspired by how humans learn. By starting with easier examples, the machine learning model grasps core concepts before tackling more challenging ones. Such technique builds a solid foundation for learning complex tasks later. Accordingly, the domain adaptation system 104 may prioritize learning from easy-to-learn samples first. Easy-to-learn samples may be identified based on pseudo-label reliability (confidence/uncertainty).

Identifying casy samples allows domain adaptation system 104 to select high-quality labels that are more likely to be correct. Domain adaptation system 104 may follow a carefully designed curriculum.

Domain adaptation system 104 may start with learning from highly reliable, “easy” pseudo-labels 314. Domain adaptation system 104 may gradually refine and propagate label information to less reliable, “hard” samples 318. Unsupervised contrastive representation learning may help prevent ETM by encouraging the model to learn noise-robust features without relying solely on potentially noisy labels. By focusing on more reliable labels 314 and controlling propagation, domain adaptation system 104 may enhance the overall accuracy and may reduce noise impact.

The techniques may reduce a need for expensive memory banks or complex label refinement techniques. Domain adaptation system 104 may be suitable for both offline and online domain adaptation scenarios. Domain adaptation system 104 may prioritize using reliable pseudo-labels for self-training to avoid memorizing noisy labels early on. Domain adaptation system 104 may leverage the inherent reliability information within the generated pseudo-labels, such as prediction confidence or uncertainty scores. Domain adaptation system 104 may initially train on the most reliable, “easy” pseudo-labels 314. As the model improves, domain adaptation system 104 may gradually incorporate less reliable, “hard” pseudo-labels 318 with carefully refined information. FIG. 3 visually illustrates the benefit of the disclosed techniques, depicting how avoiding carly memorization of noisy labels 318 ultimately leads to improved self-training accuracy and performance.

By prioritizing learning from highly reliable pseudo-labels, domain adaptation system 104 may gradually propagate refined and accurate label information to less reliable samples. Such selective techniques may ensure that noise from unreliable labels 318 initially has minimal impact on the learning process. Reliability for a pseudo-label may be computed as a reliability score. Reliability scores may fall within a defined range. A pseudo-label may be considered “reliable” if it satisfies a reliability score threshold. Domain adaptation system 104 may be configured with multiple reliability score thresholds that define different levels of reliability. The pseudo-label selection techniques may progressively train on less and less reliable subsets of pseudo-labels. For example, the first training iteration may draw from the most reliable pseudo-labels having reliability scores that satisfy the highest reliability score threshold, while the next training iteration draws from pseudo-labels that satisfy the next highest reliability score, and so on.

Traditional SFDA approaches often rely on memory-bank-dependent label refinement techniques to improve pseudo-label accuracy. Domain adaptation system 104 may reduce or even eliminate the need for these costly refinement steps by focusing on selecting and utilizing the most reliable labels from the outset. By prioritizing reliable labels 314, domain adaptation system 104 is less likely to memorize noise and can achieve better overall performance on the target domain. Reducing or even eliminating the memory bank and complex refinement algorithms may reduce the computational cost and memory footprint of the adaptation process. Furthermore, the disclosed techniques become feasible for deployment on devices with limited resources, expanding the potential applications of domain adaptation system 104.

Domain adaptation system 104 may achieve SOTA performance on major benchmarks for both image recognition and semantic segmentation tasks. SOTA performance indicates the effectiveness of the domain adaptation system 104 in adapting models to new domains while maintaining high accuracy. Domain adaptation system 104 may be deployable on devices with limited memory, expanding its application scenarios. Domain adaptation system 104 may readily adapt to new data as it arrives, making it valuable for real-time scenarios.

In an aspect, domain adaptation system 104 may define source domain data set Dₛ. Dₛ may contain Nₛ labeled samples, cach represented as a pair (xⁱₛ, yⁱₛ).

xⁱₛ may be a data sample (e.g., an image). yis may be one-hot ground-truth label vector corresponding to xⁱₛ, indicating the sample's class among K possible classes. The source domain data set may represent the domain where the model was initially trained. f_{θs} may be source model 320. The source model 320 may be a model trained on Dₛ to predict labels for source domain samples. Source model 320 may consist of two main components. Feature extractor (G) may extract meaningful features from input samples. Fully connected (FC) classifier (C) may use the extracted features to predict class probabilities. Target domain dataset Dₜ 322 may contain Nₜ unlabeled samples, xⁱₛ, without their corresponding ground-truth labels. Target domain dataset 322 may represent the domain where the model needs to be adapted without accessing the original labels. Both Dₛ and Dₜ may share the same underlying label distribution with K classes. In other words, the illustrated model may aim to predict the same set of classes in both domains. The goal of the domain adaptation system 104 may be to adapt the source model f_{θs} to perform well on the target domain Dₜ 322 without accessing the source data (Dₛ) during adaptation. Such constraint may make SFDA problem more challenging as the model cannot directly leverage source domain information for refining its decision boundaries. While domain adaptation system 104 does not have access to target labels for training, the domain adaptation system 104 may use the target labels for evaluation purposes to assess the adapted model's performance on the target domain.

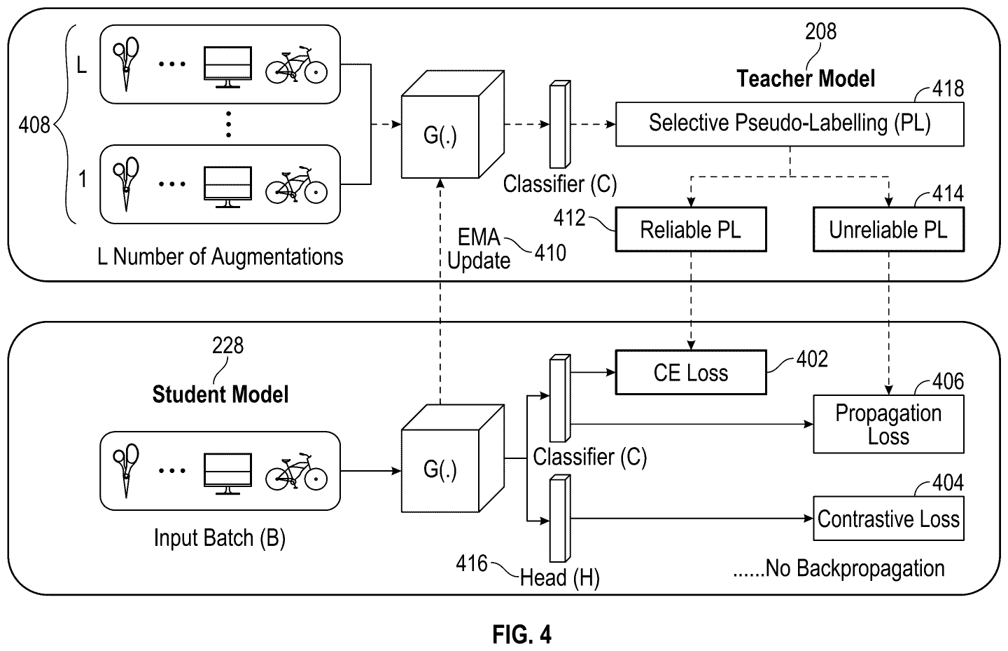

FIG. 4 is a conceptual diagram illustrating a method that uses teacher predictions to train the student model according to techniques of this disclosure. Teacher model 208 may be the source model f_{θs} 320 shown in FIG. 3, trained on the source domain, which may act as a teacher to provide guidance for the student model 228. Student model 228 may be a model with the same architecture as the teacher model 208, being adapted to the target domain 322.

Teacher model 208 may use only the pseudo-labels with high confidence or low uncertainty to minimize noise. In an aspect, the teacher model may employ cross-entropy (CE) loss 402 to train student model 228 based on reliable pseudo-labels. The teacher model 208 may incorporate unsupervised contrastive loss 404. In an aspect, teacher model 208 may encourage learning discriminative features without relying on potentially noisy labels.

In one example, teacher model 208 may strengthen model generalization. As the confidence of student model 228 improves, teacher model 208 may gradually distribute high-quality label information to unreliable samples. Teacher model 208 may leverage label propagation loss 406 to reinforce correct predictions and correct potential errors. Teacher model 208 may effectively expand the pool of reliable samples for further training. Selective and progressive self-training may minimize the impact of noisy pseudo-labels carly on. The selective and progressive self-training may gradually refine labels and expand the reliable set. Teacher model 208 may reduce noise sensitivity. Teacher model 208 may improve performance on unseen target domain data.

In FIG. 4, teacher model (f_{\hat{θ}}_{ₜ}) 208 may be a copy of the source model (f_{θ}_{ₜ}) 320 initially, used to generate pseudo-labels for target domain samples. Student model (f_{θ}_{ₜ}) 228 may be the model being adapted to the target domain, trained using pseudo-labels from the teacher model 208.

The teacher model may predict labels for target domain samples, providing pseudo-labels ýₜ. The generated pseudo-labels may serve as temporary surrogates for the missing ground-truth labels in the target domain.

In an aspect, target domain samples may be divided into batches of size B. It should be noted that for each batch, the corresponding pseudo-labels ŷₜⁱ may be used to train student model 228, using the following formula (1):

$${ℒ}_{c e} = - \frac{1}{B} {\sum }_{i = 1}^{B} {\hat{y}}_{t c}^{i} \cdot log {f}_{{θ}_{t}} ( {x}_{t}^{i} ) \qquad ( 1 )$$

where ŷ_{tc}ⁱ is the one-hot encoded pseudo-label for sample ŷₜⁱ.

Minimizing [symbol] _{ce} 402 encourages student model 228 to align its predictions with the teacher model's 208 guidance. To ensure consistency and smooth knowledge transfer, both teacher 208 and student models 228 may begin with the same weights 230 (θₜ=\hat{θ}ₜ, =θₛ). By minimizing [symbol] _{ce} 402, student model 228 may be trained to produce predictions that are consistent with those of the teacher model 208. In other words, consistency enforcement iteratively refines the ability of student model 228 to adapt to the target domain, even without access to ground-truth labels. Pseudo-labeling substitutes for missing ground-truth labels in SFDA. CE loss 402 may ensure consistency between student and teacher predictions.

In an aspect, domain adaptation system 104 may leverage data augmentation 408 to generate multiple versions (L copies) of each target domain sample (xₜ). Teacher model 208 may predict a label for each augmented version (\hat{x}ₜ¹, xₜ¹). Instead of using the prediction for the original sample (xₜ), teacher model 208 may average the predictions from all L augmented versions to obtain a more robust and consistent pseudo-label ýₜ. Averaging predictions weakens the influence of potential outliers or noisy predictions from individual augmentations. Data augmentation 408 exposes the model to diverse versions of the data, enhancing its ability to generalize to unscen samples.

Domain adaptation system 104 may utilize a general-purpose augmentation policy applicable to multiple datasets, simplifying implementation. Domain adaptation system 104 may employ an exponential moving average (EMA) 410 to update the teacher model 208 weights during cach training iteration. Instead of directly using student model's current weights 230 to update teacher 208, domain adaptation system 104 may use an exponentially weighted average of past weights. EMA 410 may incorporate past information, preventing drastic changes due to potentially noisy updates from student model 228. Consistent teacher predictions may contribute to more reliable pseudo-labels for the student model. The smoothing factor (γ) may allow fine-tuning the degree of change and stability desired in teacher model 208.

While data augmentation and weight averaging mitigate noise, a batch of pseudo-labels might still contain outliers or errors. Curriculum learning may start with simple tasks or easy-to-learn examples. Domain adaptation system 104 may identify trustworthy labels based on confidence scores, uncertainty estimates, or other metrics. Domain adaptation system 104 may focus on these reliable labels 412 for initial self-training, preventing noise propagation carly on.

As a result of filtering out noise and prioritizing reliable labels 412, student model 228 may be less likely to memorize erroneous information. Learning from confident labels first may facilitate faster progress and efficient utilization of training resources. Student model 228 may develop a stronger foundation built on accurate information, leading to better overall performance and adaptability.

A well-calibrated model's prediction confidence often strongly correlates with accuracy. Entropy captures the degree of uncertainty in a model's predictions. Lower entropy (higher certainty) may indicate more reliable pseudo-labels. In an aspect, to estimate entropy in SFDA, domain adaptation system 104 may create virtual distribution shifts within the target domain using carefully designed data augmentation 408. Domain adaptation system 104 may measure prediction variance or uncertainty over these augmented distributions to approximate actual domain shift. The reliability of confidence scores may depend on the model being well-calibrated.

In an aspect, domain adaptation system 104 may assign each target sample (xₜⁱ) a binary score (rⁱ) indicating its label reliability. A score of 1 may signify a reliable label 412, while 0 may suggest potential noise or uncertainty (unreliable label 414). In an aspect, prediction confidence (conf(ŷₜ¹)) may be the measure of the model's confidence in its prediction for the sample. Prediction uncertainty (gᵤⁱ) may measure the degree of uncertainty in the prediction, estimated using aleatoric uncertainty.

In an aspect, a sample may be deemed reliable if its prediction confidence exceeds a threshold τ_{c} and its prediction uncertainty falls below a threshold τᵤ. In an aspect, domain adaptation system 104 may calculate gᵤⁱ using the standard deviation of the model's predictions across multiple augmented versions of the sample, represented by the following formula (2):

$${g}_{u}^{i} = std {\{ {\hat{y}}_{t}^{l} \}}_{l = 0}^{l = L} \qquad ( 2 )$$

Aleatoric uncertainty may be preferred for its robustness to domain shifts. Domain adaptation system 104 may adaptively estimate the thresholds for each batch of samples. τ_{c} may be average confidence over the batch and τᵤ may be average uncertainty over the batch. These may be computed as:

$${τ}_{c} = {\sum }_{i = 1}^{i = B} conf ( {\hat{y}}_{t}^{i} ) ; {τ}_{u} = {\sum }_{i = 1}^{i = B} {g}_{u}^{i}$$

Estimating thresholds may eliminate the need for dataset-specific hyperparameter tuning, enhancing adaptability. After assigning reliability scores (rᵢ) to each sample, domain adaptation system 104 may divide the input batch D into two groups D_{R} and D_{U}. D_{R} may be reliable samples 412 with rᵢ=1. D_{U} may be less reliable samples with rᵢ=0. While D_{R} may contain high-confidence samples, D_{R} may lack diversity or even miss entire categories. To address diversity, domain adaptation system 104 may selectively add samples from D_{U} based on the Top-2 confidence score difference (DOC). The DOC metric may help identify samples that are relatively more confident within the less reliable group.

For D_{R}, domain adaptation system 104 may use class-balanced cross-entropy loss ( [symbol] _{ce}^{R}) 402 to account for potential label imbalance. Domain adaptation system 104 may incorporate an inverse frequency loss-weighting factor (λₖ) to further address class imbalance, giving more weight to rare classes. For D_{U}, domain adaptation system 104 may employ label propagation loss (L_{P}) 406 to transfer label information from reliable samples in D_{R} to less reliable samples in D_{U}. L_{P} 406 may leverage similarities between samples to refine labels for D_{U}, guided by knowledge from D_{R}. The transductive nature of L_{P} may allow it to work directly on unlabeled data (D_{U}) by utilizing information from labeled data (D_{R}). Transductive label propagation enables label refinement and knowledge transfer without requiring ground-truth labels for D_{U}. It should be noted that there is potential for memorization due to relying on pseudo-labels in both cross-entropy loss ( [symbol] _{ce}^{R}) 402 and label propagation (L_{P}) 406. To address mitigation of memorization risk, domain adaptation system 104 may incorporate unsupervised contrastive learning (CL), which encourages learning useful representations without relying on potentially noisy pseudo-labels. One of the key advantages of the unsupervised CL is that learning is driven by similarities between augmented versions of the same sample, independent of their pseudo-labels. Unsupervised CL may focus on capturing meaningful features not solely tied to specific labels, potentially improving generalization. Domain adaptation system 104 may employ a projection head (H) 416 to obtain feature representations from data augmentations of each sample. A contrastive criterion may encourage similarity between representations of the same sample's augmentations while pushing apart different samples' representations. While label-dependent CL has been used in SFDA, domain adaptation system 104 emphasizes using label-independent CL, especially early in training. Such choice may further minimize the influence of potentially noisy labels, particularly when the model's self-training is still in its initial stages.

Domain adaptation system 104 may incorporate curriculum learning, aligning with the principle of starting with casier tasks and gradually progressing to harder ones. Based on reliable label selection 418 performed by domain adaptation system 104, as described above, D_{R} samples (those with high confidence and low uncertainty) may be considered casier due to their likely correct pseudo-labels. Conversely, D_{U} samples (lower confidence or higher uncertainty) may be deemed harder due to the potential for noise in their pseudo-labels. In an aspect, domain adaptation system 104 may employ an update equation (3) for the labeled loss coefficient (μᵣ) that adjusts based on the difficulty score (d^{j}) of the current batch:

$${μ}_{r}^{j} = {μ}_{r}^{j - 1} ( 1 - α {e}^{- \frac{1}{{d}^{j}}} ) \qquad ( 3 )$$

The difficulty score may reflect the relative difficulty between D_{R} and D_{U} samples (Tτᵤ/τ_{c}, ratio of uncertainty threshold to confidence threshold). As training progresses and student model 228 gains confidence in its pseudo-labels (overall reliability improves), domain adaptation system 104 may gradually increase focus on learning from D_{U} (less reliable samples). Such increased focus may be achieved by decreasing the labeled loss coefficient (μᵣ), allowing more influence from the loss associated with learning from Du samples. The rate of decrease in μᵣ is directly affected by the difficulty of the current batch (reflected by the difficulty score d^{j}). High difficulty (high d^{j}) may indicate a hard-to-learn batch, prompting domain adaptation system 104 to minimize the change in μᵣ, cautiously incorporating D_{U} learning to avoid potential noise amplification. Conversely, low difficulty may encourage a faster decrease in μᵣ, enabling more learning from D_{U} as domain adaptation system 104 gains confidence. The contrastive loss coefficient (μ_{c}) 404, responsible for unsupervised feature learning, may also be exponentially decreased throughout training using the following equation (4):

$${μ}_{c}^{j} = {μ}_{c}^{j - 1} {e}^{- β} \qquad ( 4 )$$

Domain adaptation system 104 may initialize μ⁰_{c} at 0.5, emphasizing unsupervised feature learning's importance during early training when reliable labels are less established.

In one implementation, student model 228 may be a component of image processing module 108, as shown in FIG. 2. Image processing module 108 may assign a label to each pixel, contrasting with classification's single label per sample. The student model 228 may produce a probabilistic output prediction (p) over K classes for each pixel, rather than a single class prediction. The pseudo-label map ŷ) may be estimated by assigning the most probable class (ŷ=arg maxₖ p) to each pixel. Instead of a single threshold for all pixels, image processing module 108 may determine separate confidence and uncertainty thresholds (τ_{c}^{k}, τᵤ^{k}) for each category (k). For each category, the confidence threshold (tτ_{c}^{k}) may be estimated as the P-th percentile confidence score within a batch, ensuring a consistent level of confidence across categories. Semantic segmentation datasets often exhibit class imbalance, with varying frequencies of different categories. Per-category thresholds allow for adaptivity to these imbalances, preventing categories with naturally lower scores from being disproportionately discarded. Such techniques may improve the reliability of selected pseudo-labels by considering the model's confidence within each category specifically. The confidence and uncertainty thresholds may be category-specific, calculated as the P-th percentile of confidence and uncertainty scores within a batch (P=55 in one implementation.) For reliable pixels (ŷ^{R}), image processing module 108 may employ cross-entropy loss ( [symbol] _{ce}^{R}) 402 to optimize label predictions. Additionally, image processing module 108 may introduce prediction entropy loss (L_{E}) to encourage diverse predictions across different classes. The prediction entropy loss penalizes models that consistently predict the same class for most pixels, promoting exploration and potentially avoiding getting stuck in local optima. Image processing module 108 may minimize the total loss (Lₜₒₜ), combining [symbol] _{ce}^{R} and L_{E} with a coefficient (μₑ) that controls the influence of entropy loss. Similar to contrastive loss 404 described above, μₑ may be exponentially decreased during training (inspired by equation (4)), with an initial value of μ⁰ₑ=1e-3. Advantageously, image processing module 108 may update only the Batch Normalization (BN) layers, while freezing other model parameters. Such update might imply a focus on adapting the model's ability to handle different data distributions while preserving learned features. To estimate uncertainty, image processing module 108 may use ColorJitter and Gaussian noise as data augmentation transformations. Additional description is found in U.S. Patent Application No. 63/454,570, filed Mar. 24, 2023, which is incorporated by reference herein in its entirety.

FIG. 5 illustrates self-training with pseudo label self-refinement method, according to techniques of this disclosure. The illustrated techniques address challenges of nighttime semantic segmentation, for example.

The method illustrated in FIG. 5 builds upon the techniques described above, where teacher model 208 generates pseudo-labels for unlabeled target domain data 322 to train student model 228. To enhance pseudo-label quality online (during training) for more effective student model 228 learning, domain adaptation system 104 may utilize refinement neural network 234. Features 504 extracted by the teacher encoder 502 may be used as input into the refinement neural network 234. Another input may include image logits 506 (prediction scores before final class assignment) from the teacher decoder 508. The refinement neural network 234 may output refined pseudo-labels 232, aiming for higher accuracy and less noise. To identify regions of the pseudo-label 232 that are likely correct, allowing for selective reweighting 512, refinement neural network may predict a “correct mask” 514. Refinement neural network 234 may predict “correct mask” 514 indicating areas where it has high confidence in the pseudo-label's 232 accuracy. In an aspect, domain adaptation system 104 may incorporate a mechanism to encourage refinement neural network 234 to prioritize less noisy features, through careful attention or feature selection strategies. Focus on less noisy features 504 may help mitigate the potential negative impact of noisy features on pseudo-label refinement. The refined pseudo-label 232 may be reweighted 512 using the predicted correct mask 514. Reweighting 512 with predicted mask 514 may give more weight to regions deemed reliable, reducing the influence of potentially incorrect or noisy areas. The goal of reweighting 512 is to guide student model 228 to focus on learning from the most accurate parts of the pseudo-label 232. The method conceptually illustrated in FIG. 5 aims to improve pseudo-label 232 quality and reduce noise propagation through online refinement, correct mask 514 prediction, noise-aware feature 504 usage, and selective reweighting 512.

FIG. 6 is a conceptual diagram illustrating an example of training a refinement neural network, according to techniques of this disclosure. Original source logits 516 may be a non-binary mask, likely containing pixel-wise probabilities or confidence scores for different classes, rather than definitive 0-1 assignments. In an aspect, domain adaptation system 104 may utilize a Fourier Transform 602, which is a mathematical technique that may be used to decompose signals into their constituent frequencies. Phase 604 and amplitude 606 are two components of Fourier transform 602. Phase 604 encodes the relative positions of different frequencies, often associated with structural or semantic information. Amplitude 606 represents the strength of each frequency, often related to texture or style information. Perturbation 608 may be a modification applied to the pseudo label (e.g., original target pseudo-label 610). Domain adaptation system 104 may apply Fourier transform 602 to the original source logits 516, separating its phase 604 and amplitude 606 components. In an aspect, domain adaptation system 104 may use Fourier amplitude 606A from original target logits 610 to replace or modify the amplitude of the logits 516. Such amplitude manipulation may transfer style information from the original target pseudo-label 610 to the perturbed source pseudo-label 612, potentially improving its accuracy and structure. Domain adaptation system 104 may apply an inverse Fourier transform 614 to the combined amplitude 606A-606B and original phase 604 (from original logits 516) to reconstruct a perturbed pseudo-label 612. The disclosed techniques provide a creative way to introduce noise specific to the target domain. In an aspect, domain adaptation system 104 takes the amplitude component from the source image logits and mixes it with the amplitude of a random target image, so that training supervision may be provided by source labels. Such operation essentially injects some of the style variations from the target domain into the source logits. Importantly, by keeping the phase component from the source domain intact, domain adaptation system 104 ensures the semantic information (object identity) remains unchanged.

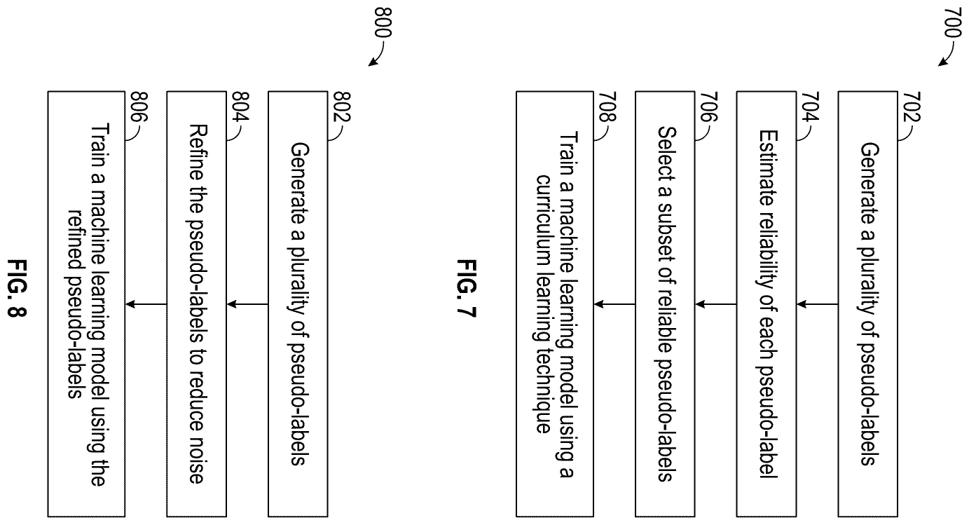

FIG. 7 is a flowchart illustrating an example mode of operation for a machine learning system, according to techniques described in this disclosure. Although described with respect to computing system 200 of FIG. 2 having processing circuitry 243 that executes Domain adaptation system 104, mode of operation 700 may be performed by a computation system with respect to other examples of machine learning systems described herein.

In mode operation 700, processing circuitry 243 executes domain adaptation system 104. Domain adaptation system 104 may generate a plurality of pseudo-labels for a dataset of unlabeled data (702). For example, in FIG. 4, teacher model 208 may be a copy of the source model 320 initially, used to generate pseudo-labels for target domain samples. Domain adaptation system 104 may next estimate reliability of each of the plurality of pseudo-labels using one or more reliability measures (704). In an aspect, domain adaptation system 104 component of the domain adaptation system 104 may assign cach target sample a binary score indicating its label reliability. Next, domain adaptation system 104 may select a subset of the plurality of pseudo-labels based on the estimated reliability (706). In an aspect, the selected subset of the plurality of pseudo-labels may include reliable pseudo-labels. It should be noted that domain adaptation system 104 may focus on selecting and utilizing the most reliable pseudo-labels from the outset. In an aspect, domain adaptation system 104 may train a machine learning model using one or more curriculum learning techniques starting with the selected subset of the plurality of pseudo-labels (708). Teacher model 208 may be the source model, trained on the source domain, which may act as a teacher to provide guidance for the student model 228.

FIG. 8 is a flowchart illustrating an example mode of operation for a machine learning system to perform self-refinement of pseudo-labels, according to techniques described in this disclosure. Although described with respect to computing system 200 of FIG. 2 having processing circuitry 243 that executes domain adaptation system 104, mode of operation 700 may be performed by a computation system with respect to other examples of machine learning systems described herein.

In mode operation 800, processing circuitry 243 executes domain adaptation system 104. Domain adaptation system 104 may generate a plurality of pseudo-labels for a dataset of unlabeled data (802). For example, in FIG. 4, teacher model 208 may be a copy of the source model 320 initially, used to generate pseudo-labels for target domain samples. Domain adaptation system 104 may next refine the plurality of pseudo-labels to reduce noise (804). In an aspect, output of the refinement neural network 234 may be refined pseudo-label 232 that is potentially more accurate than the original one. Refinement neural network 234 may combine the input features and image logits to generate a prediction of the “correct” segmentation mask for the target image. In an aspect, domain adaptation system 104 may train a student/target machine learning model using the refined pseudo-labels (806).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for unsupervised domain adaptation, the method comprising:
generating a plurality of pseudo-labels for a dataset of unlabeled data using a source machine learning model;
estimating a reliability of each pseudo-label of the plurality of pseudo-labels using one or more reliability measures;
selecting a subset of the plurality of pseudo-labels having estimated reliabilities that satisfy a reliability threshold; and
training, using one or more curriculum learning techniques, a target machine learning model starting with the selected subset of the plurality of pseudo-labels and the corresponding unlabeled data.

2. The method of claim 1, wherein the source machine learning model comprises a teacher model and the target machine learning model comprises a student model.

3. The method of claim 1, wherein estimating a reliability comprises:
assigning a score to each pseudo-label of the plurality of pseudo-labels indicating reliability of the pseudo-label.

4. The method of claim 3, wherein selecting a subset comprises:
selectively grouping the plurality of pseudo-labels into two or more groups based on the assigned score.

5. The method of claim 1, wherein training the target machine learning model comprises adapting the target machine learning model to new domain data without access to original training data.

6. The method of claim 5, wherein the new domain data comprises unlabeled nighttime image data.

7. The method of claim 1, wherein the one or more curriculum learning techniques include unsupervised contrastive learning (CL).

8. A computing system for unsupervised domain adaptation comprising:
processing circuitry in communication with storage media, the processing circuitry configured to execute a machine learning system configured to:
generate a plurality of pseudo-labels for a dataset of unlabeled data using a source machine learning model;
estimate a reliability of each pseudo-label of the plurality of pseudo-labels using one or more reliability measures;
select a subset of the plurality of pseudo-labels having estimated reliabilities that satisfy a reliability threshold; and
train, using one or more curriculum learning techniques, a target machine learning model starting with the selected subset of the plurality of pseudo-labels and the corresponding unlabeled data.

9. The system of claim 8, wherein the source model comprises a teacher model and the target model comprises a student model.

10. The system of claim 8, wherein the machine learning system configured to estimate a reliability is further configured to:
assign a score to each pseudo-label of the plurality of pseudo-labels indicating reliability of the pseudo-label.

11. The method of claim 10, wherein the machine learning system configured to select a subset is further configured to:
selectively group the plurality of pseudo-labels into two or more groups based on the assigned score.

12. The system of claim 8, wherein the machine learning system configured to train the target machine learning model is further configured to adapt the machine learning model to new domain data without access to original training data.

13. The system of claim 12, wherein the new domain data comprises unlabeled nighttime image data.

14. The system of claim 8, wherein the one or more curriculum learning techniques include unsupervised contrastive learning (CL).

15. A method for unsupervised domain adaptation, the method comprising:
generating a plurality of pseudo-labels for a dataset of unlabeled data using a source machine learning model;
refining the plurality of pseudo-labels to reduce noise in the plurality of pseudo-labels; and
training, using the refined pseudo-labels, a target machine learning model.

16. The method of claim 15, wherein the source machine learning model comprises a teacher model and the target machine learning model comprises a student model.

17. The method of claim 16, wherein refining the plurality of pseudo-labels comprises refining, using a refinement neural network, one or more of the plurality of pseudo-labels to improve accuracy of the one or more of the plurality of pseudo-labels.

18. The method of claim 17, wherein the teacher model comprises a teacher encoder and a teacher decoder and wherein one or more features from the teacher encoder and image logits from the teacher decoder are inputted into the refinement neural network.

19. The method of claim 18, further comprising:
training the refinement neural network.

20. The method of claim 19, wherein training the refinement neural network comprises:
applying a Fourier transform to each of the plurality of source image logits and target image logits to separate a phase component and an amplitude component, wherein the phase component contains semantic information and wherein the amplitude component contains style information.

21. The method of claim 20, wherein training the refinement neural network further comprises:
modifying the amplitude of the source image logits using the amplitude of a random target image logit to introduce noise while preserving semantic structure.

22. The method of claim 19, wherein training the refinement neural network comprises:
using a predicted mask as a weighting factor in training the target machine learning model.

23. A computing system for unsupervised domain adaptation comprising:
processing circuitry in communication with storage media, the processing circuitry configured to execute a machine learning system configured to:
generate a plurality of pseudo-labels for a dataset of unlabeled data using a source machine learning model;
refine the plurality of pseudo-labels to reduce noise in the plurality of pseudo-labels; and
train, using the refined pseudo-labels, a target machine learning model.

24. The system of claim 23, wherein the source machine learning model comprises a teacher model and the target machine learning model comprises a student model.

25. The system of claim 24, wherein the machine learning system configured to refine the plurality of pseudo-labels is further configured to refine, using a refinement neural network, one or more of the plurality of pseudo-labels to improve accuracy of the one or more of the plurality of pseudo-labels.

26. The system of claim 25, wherein the teacher model comprises a teacher encoder and a teacher decoder and wherein one or more features from the teacher encoder and image logits from the teacher decoder are inputted into the refinement neural network.

27. The system of claim 26, wherein the machine learning system is further configured to:
train the refinement neural network.

28. The system of claim 27, wherein the machine learning system configured to train the refinement neural network is further configured to:
apply a Fourier transform to each of the plurality of source image logits and target image logits to separate a phase component and an amplitude component, wherein the phase component contains semantic information and wherein the amplitude component contains style information.

29. The system of claim 28, wherein the machine learning system configured to train the refinement neural network is further configured to:
modify the amplitude of the source image logits using the amplitude of a random target image logit to introduce noise while preserving semantic structure.

30. The system of claim 27, wherein the machine learning system configured to train the refinement neural network is further configured to:
use a predicted mask as a weighting factor in training the target machine learning model.
